(19) United States
(12) Patent Application Publication
(10) Pub. No.: US 2008/0161057 A1
(43) Pub. Date: Jul. 3, 2008

(54) VOICE CONVERSION IN RING TONES AND OTHER FEATURES FOR A COMMUNICATION DEVICE

(75) Inventors: Jani Kristian Nurminen, Lempaala (FI); Kimmo Matias Parssinen, Tampere (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/963,159

(22) Filed: Dec. 21, 2007

Related U.S. Application Data
(63) Continuation-in-part of application No. 11/107,344, filed on Apr. 15, 2005.

(51) Int. Cl. H04B 1/38

(52) U.S. Cl. 455/563

(57) ABSTRACT

A voice conversion processing framework is operatively associated with the central processing unit (CPU) and audio processor of a communication device to convert default voice presentations generated by, for example text readers, ring tone applications and the like, to target voice presentations based on selected target voice files stored in memory.

### RELATED APPLICATIONS

This application is a continuation in part application based on U.S. patent application Ser. No. 11/107,344, filed Apr. 15, 2005, US Publication No. 2006/0235685 and claims priority from this application with respect to common subject matter. The disclosure of application Ser. No. 11/107,344 is incorporated herein by reference.

### BACKGROUND

1. Field

The disclosed embodiments generally relate to voice synthesis and, more particularly, to voice conversion for audio user interfaces in communication devices.

2. Brief Description of Related Developments

Voice conversion can be defined as the modification of speaker-identity related features of a speech signal. Commercial usage of voice conversion techniques is at its infancy. In one application, voice conversion may be utilized to extend the language portfolio of Text-To-Speech (TTS) systems using branded voices in a cost efficient manner. In this context, voice conversion may, for instance, be used to make a branded synthetic voice speak in languages that the original voice talent cannot speak. In addition, voice conversion may be deployed in several types of entertainment applications and games, and communication.

A plurality of voice conversion techniques are known in the art, in many of which, a speech signal is represented by a source-filter model of speech. In these contexts speech is understood to consist of a source component originating from the vocal cords, which is then shaped by a filter imitating the effect of the vocal tract. The source component is frequently denoted as an excitation signal, as it excites the vocal tract filter. A separation (or de-convolution) of a speech signal into the excitation signal on the one hand, and the vocal tract filter on the other hand can for instance be accomplished by cepstral analysis or Linear Predictive Coding (LPC). A voice conversion platform is described in the above referenced application, US Publication No. 2006/0235685, incorporated herein by reference.

It would be advantageous to adapt such voice conversion techniques to enhance the audio user interface of communication devices by expanding the use of voice based presentations.

### SUMMARY OF THE EMBODIMENTS

In the basic embodiment of this application, a voice conversion processing framework, as described in US Publication 20060235685, or other modules using similar techniques is operatively associated with the central processing unit (CPU) and audio processor of a communication device. The voice conversion processor is used to enhance the features of the audio portion of the user interface of the communication device. This is accomplished by using source voice signals available in memory or from other speech processing features to convert a default source speech to a target speech. Such target voice signals may be provided by network supplied applications or by applications that are part of the operating system of the communication device.

In another embodiment of this application, a feature is provided that generates an audio presentation of a text message using text to speech (TTS) synthesis. According to this embodiment, an audio field is established as part of a contact listing or profile, using tools, similar to audio name identification tools that are currently available in communication devices, in particular a mobile communication device. This audio file is used to convert the default voice used for the text message reading feature into a target speech customized by the user, for example the voice of the sender.

In another embodiment of the application, voice conversion techniques are used to customize speech related ring tones, such as caller ID announcements, ring tones using in part TTS generated voice synthesis, ring tones generated by user recording, and other sources. The target speech source could be the user's voice or the voice of a friend, or celebrity. A wide variety of target sources may be made available.

### BRIEF DESCRIPTION OF THE DRAWINGS

These aspects and other features of the embodiments are explained in the following description, with reference to the accompanying drawings, in which:

FIG. 1 shows a block diagram of a voice conversion framework, that may be used in accomplishing the disclosed embodiments;

FIG. 2 shows a block diagram of a communication device, in which aspects of the disclosed embodiments may be applied;

FIG. 3 shows a block diagram of a communication device adapted in an embodiment of this application;

FIG. 4 shows a block diagram of a communication device adapted in an alternate embodiment of this application;

FIG. 5 shows a block diagram of a communication device adapted in another alternate embodiment of this application; and

FIG. 6 shows a diagram of an embodiment of the method of this application.

### DETAILED DESCRIPTION OF THE EMBODIMENTS

Although aspects of the disclosed embodiments will be described with reference to the embodiments shown in the drawings and described below, it should be understood that these aspects could be embodied in many alternate forms. In addition, any suitable size, shape or type of elements or materials could be used. Computer operated devices may be constructed having one or several processors and one or several program product modules stored in one or several memory elements. For illustration, computer components may be described as individual units by function. It should be understood, that in some instances, these functional components may be combined. The operation of the communication device of this application uses conventional stored-program processor elements and may include, for example, processor, and memory that perform processing and storage operations in connection with operation of the device.

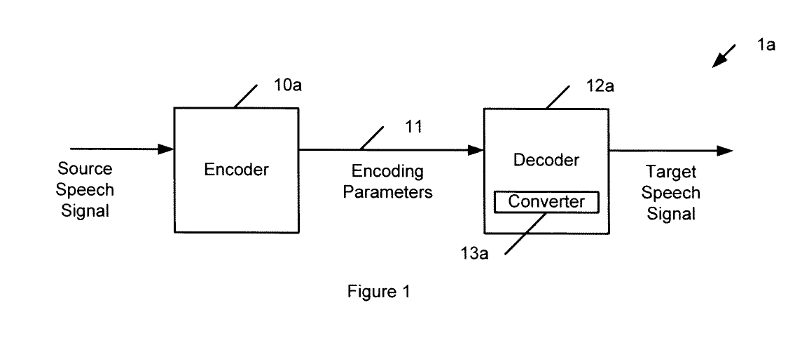

An example of a framework 1 for accomplishing voice conversion is shown in FIG. 1. Framework 1 is described in detail in the patent application referenced above and is an example of a voice conversion system that may be adapted for use in the embodiments of this application. Other techniques and frameworks could be used to provide the voice conversion function according to this application. In framework 1, a source speech signal that is associated with a source voice is fed into an encoder 10a that encodes said source speech signal into samples of encoding parameters. The samples of the encoding parameters are then transferred via a link 11 to decoder 12a, where a target speech signal is obtained by means of decoding. The target speech signal may be a representation of said source speech signal, but is associated with a target voice that is different from said source voice. The actual conversion of the source voice into the target voice is accomplished by a converter, which may either be located in the encoder or in the decoder. In framework 1a, decoder 12a is understood to house the converter 13a, however it may also be implemented in encoder 10a. Converter 13a converts samples of parameters that are related to the source speech signal into samples of parameters that are related to the target signal.

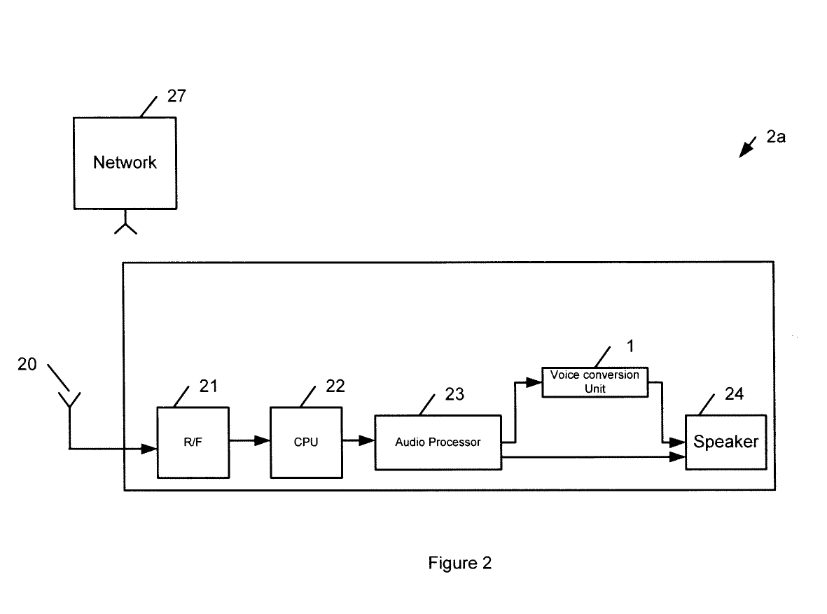

FIG. 2 depicts a block diagram of a communications device 2, such as for instance a mobile phone, that is operated in a mobile communications system 27. Said device 2 comprises an antenna 20, an R/F instance 21, a Central Processing Unit (CPU) 22, an audio processor 23 and a speaker 24. Typically use of device 2 involves the establishment of a call via a core network of said mobile communications system. In the schematic representation of FIG. 2, only the components of device 2 that are of interest for reception of speech signals are shown. Electromagnetic signals carrying a representation of speech signals are for instance received via antenna 20, amplified, mixed and analog-to-digital converted by R/F instance 21 and forwarded to CPU 22, which processes the digital speech signal and triggers audio processor 23 to generate a corresponding analog speech signal that can be emitted by speaker 24.

According to the embodiments of this application, communication device 2 is further equipped with a voice conversion unit 1, which may be implemented according to the frameworks 1a of FIG. 1. This voice conversion unit 1 is capable of converting a voice of a source speech signal that is output by audio processor 23 from a source voice into a target voice, and to forward the resulting speech signal to speaker 24. Although the voice conversion unit 1 is illustrated as the last component before the speaker 24, it may more typically be part of speech decoding, audio processor, or speech synthesizer. This allows a user of device 2 to change voices of all speech signals that are output by audio processor 23, i.e. speech signals from mobile calls, from spoken mailbox menus, etc.

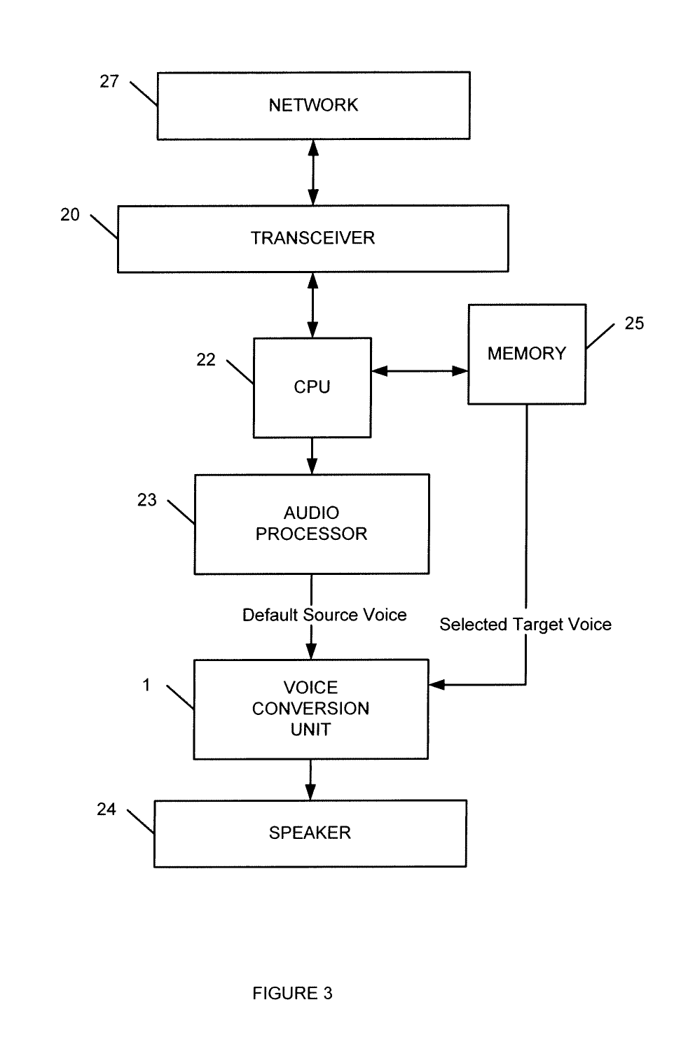

In the embodiment of FIG. 3, voice conversion processor 1 is used to enhance the features of the audio portion of the user interface of the communication device 2. The voice conversion function may be implemented in other processor modules, such as voice synthesis or decoding processors. The adaptability and use of the audio portion of a user interface in communication devices, such as device 2, has been greatly expanded through the use of new improved technologies, such as voice recognition and text to speech (TTS) processing. Through such processing, help menus and other features, such as caller ID may be implemented audibly for improved hands free operation and the overall convenience of the user. Such features generally rely on voice synthesis processing to present a friendly voice that provides the information, that otherwise might be presented only visually. It may be advantageous to change these default voice presentations to other more familiar voices, such as that of the user, celebrities or the like. This is accomplished in the embodiment of FIG. 3, by using voice signals, available in memory 25 or from other speech processing features, as target voice signals to convert a default source speech to a target speech. Such target voice signals may be provided from sources broadcast by network 27 or by internal sources stored in memory 25. The latter may be provided as part of the operating system of the communication device 2 and associated with the related selection or set up menus. In this manner a variety of alternate sources are made available for use as source voice signals and/or target voice signals.

The voice conversion feature may be accessed through a menu item selectable by the user through interaction with the user interface or in particular with the audio portion of the user interface. Multiple software modules may be stored in memory 25 having program product code that causes one or more of the cooperating processors, i.e. CPU 22, audio processor 23 and voice conversion unit 1 to cooperate to convert a source speech signal to a target speech signal using available voice conversion techniques, where the target speech signal is selected from memory 25. A particular target speech would be selected from a listing of available alternatives to the default source speech signal. A series of prompts, that could be presented as audio speech clips, would direct the user in the selection process.

The basic embodiment of this application described above can be adapted for use with a variety of source voice signals that may be generated in conjunction with the operating software system, controlling the function of a particular communication device, for example a cellular phone or other mobile communication device. In addition, this embodiment may be adapted to provide multiple choices for use as the target voice signals in converting the default source voice signals of the device. Alternate embodiments in which this flexibility is applied are discussed below.

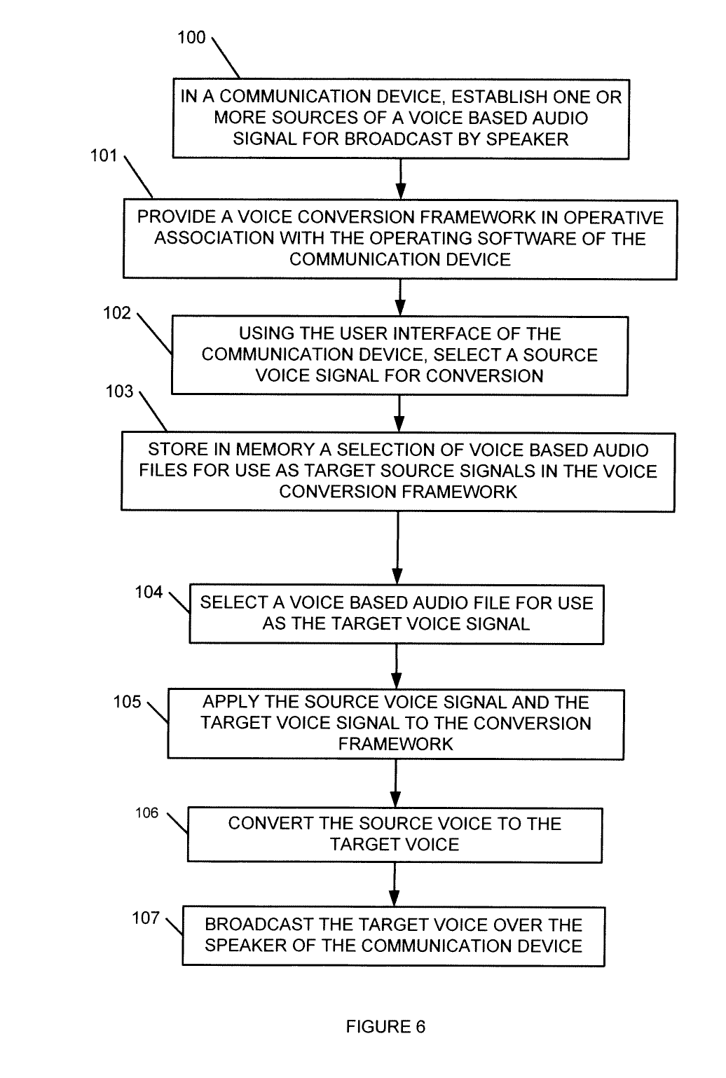

The basic method of operation of the embodiment of FIG. 3 is shown in the diagram of FIG. 6. Communication device 2 is adapted to generate at least one voice based audio signal for broadcast over speaker 24 (100). Such audio signals could be generated by several applications such as text readers or ring tones as described below. Further the communication device is constructed to include a framework 1 adapted to apply voice conversion techniques to selected voice signal sources (101). The user interface of communication device 2 is used to select the source voice signal that will be subject to conversion (102). In order to provide target voice files, a selection of voice based audio files are stored in memory 25 (103). The user interface of the communication device 2 is used to select the target voice signal into which the default source voice signal will be converted (104). The voice conversion unit/framework 1 applies voice conversion techniques to the source voice signal using the target voice signal (105,106) and the target voice signal is broadcast by the speaker 25 (107).

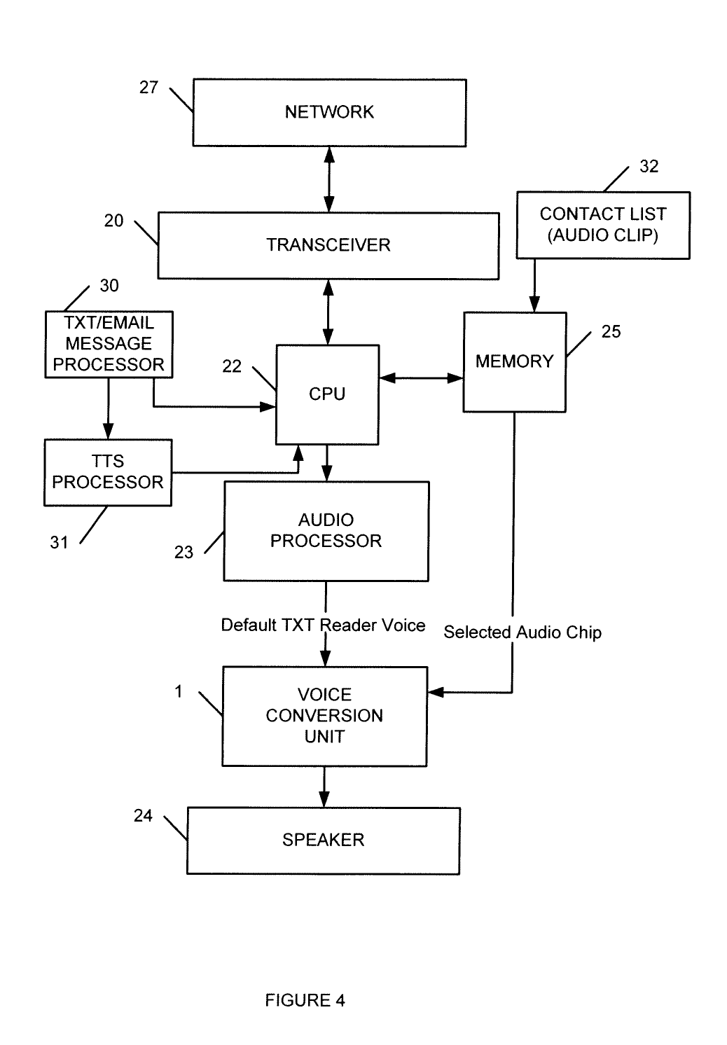

Another embodiment of this application is illustrated in FIG. 4. In this embodiment, an audio related field, in the contact list or phone book function, generally available in mobile phones and communication devices, is used to customize the text or e-mail message reader application. As shown in FIG. 4, the text or email processor 30 cooperates with TTS processor 31 to synthesize an audible presentation of the message for broadcast over the speaker 24. Although voice conversion unit 1 is illustrated in FIG. 4 as an independent functional module, it may advantageous to accomplish this function as part of the TTS processor 31 operation to optimize performance. This embodiment, uses the audio field, established as part of a contact listing or profile, using commonly available phone book program tools. The audio field is expanded to include an audio clip of a voice that may be used in association with messages and emails received from the particular contact or the clip may be selected for use in other speech based audio presentations. The voice conversion, accomplished in this application, may be based on a voice model, trained using an audio clip or target voice stored as part of the contact listing. Contact listing 32 with the audio clip is stored in memory 25 and may be accessed by the user for selection of a target voice. A particular audio clip may be selected as a target speech signal for voice conversion unit 1. The selected audio clip, or more specifically a target voice model based on the audio clip, is used to convert the default voice, used for the text/email message reading feature, into a target speech, customized by the user, for example, the voice of the sender, identified by the contact list tools. The converted speech is sent to the speaker 24 for broadcast. The audio clip must be constructed to be compatible with voice conversion framework 1.

In a mode in which the target voice signal is selected automatically from the contact listing audio clip 32. Messages from unknown contacts or from contacts that do not have any associated audio related information can be read using the default voice without conversion.

The audio related field in the contacts list can be a small audio clip. The clip could contain speech recorded from the particular contact, if the user wants to use the voice of the sender for reading the messages coming from her/him. Alternatively, the audio clip could contain speech from some other speaker that the user wants to link to the messages coming from the particular contact. The user may be prompted with respect to this feature, when the user is editing the information related to a particular contact.

In a further embodiment, the audio clip could be analyzed and used to choose between several generic voice target choices, for example based on gender. The audio clip could be used to identify the gender of the speaker and then a gender specific target voice signal could be sent to voice conversion unit 1. In other embodiments, the analysis could be more detailed, e.g. one possibility is to measure the average pitch of the speaker and to scale the pitch of the target voice signal accordingly in the message audio presentation. Another embodiment could measure the rough locations of the formats of the message and to use that data in encoding the voice used in the message reader application. In another embodiment, the analysis could contain a full-scale training of a voice conversion model for the particular speaker. This might require a second user interface to allow training voice conversion models, based on large amounts of data, to be input to voice conversion unit 1. The user could be offered a chance to link such a model to the contacts list through the audio related field.

The analysis of the audio clip can be done right after the user has added this information to her/his contacts list. In this way, the message reader itself is not abnormally complex and operation is not retarded. The result of the analysis can be stored in many formats (e.g. as some parameter settings or as a full voice conversion model).

In one alternative embodiment, the same voice can be attached to many contacts without storing duplicate information. The field in the contacts list could be a link to an audio file, making it possible to link many contacts to the same file.

In operation, when the message processor 30 receives a new message to be read, it may be adapted to check the sender field of the message and look for a match in the contacts list 32, stored in memory 25. If a match is found and an audio speech clip exists, that information may be selected and used as a target speech signal for voice conversion of the default text reader voice. If there is no audio information, or if the sender is not included in the contacts list, the message is read using the default voice according to normal execution of the message reader feature.

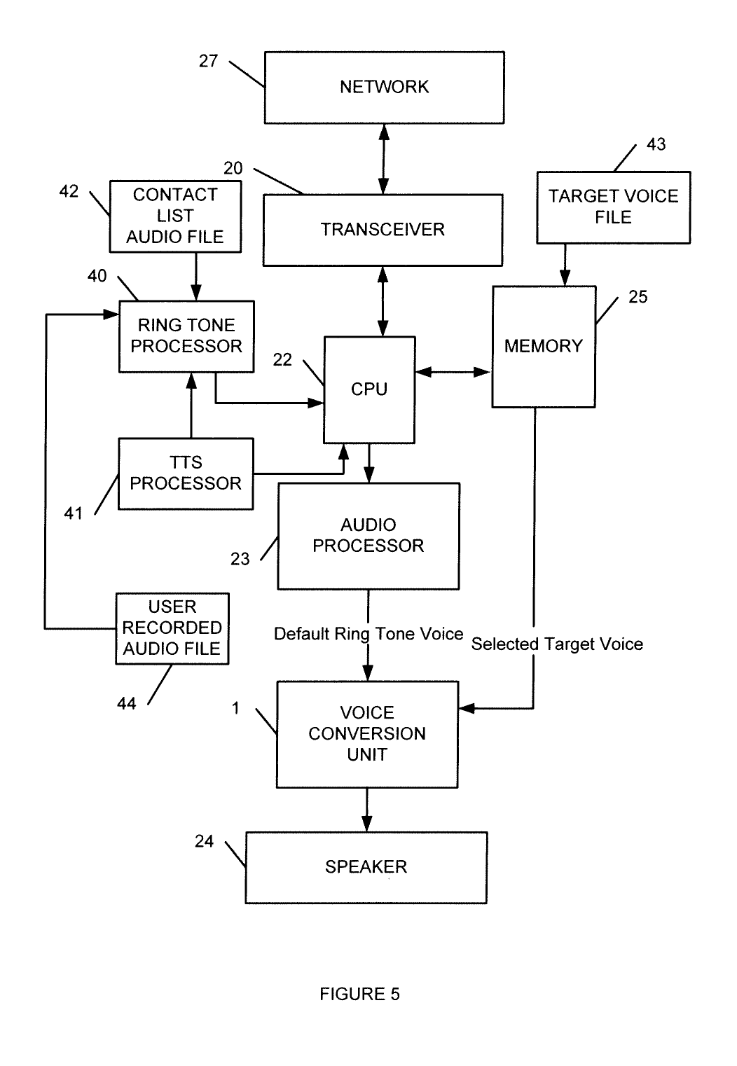

In another embodiment of this application, voice conversion techniques are used to customize speech in ring tones. As shown in FIG. 5, at least three possible choices may arise for generating source voice signals for voice conversion: the voice that is used for synthesizing the name of the caller; a ring tone generated (at least partially) using TTS synthesis; and other speech based ring tones, such as a speech based ring tones recorded by the user. The target voice in the modification could be, for example, the voice of the user, the voice of some friend, or a celebrity voice, etc. The converted speech would then be used as a ring tone according to the ring tone application. The voice related ring tone could be combined with music or other audio.

This embodiment can be implemented using existing ring tone features and voice conversion techniques. Slightly different implementations may be needed for different use cases. The usage in the existing name synthesis may require performing the conversion in the parametric domain used by the format synthesizer. The usage together with high-quality TTS synthesis is best handled by a voice conversion system that operates inside the acoustic synthesis module of the TTS system. The conversion of natural speech in ring tones may be handled using a voice conversion system that does not require any linguistic information. In any of these application modes, the conversion processing may be simplified by storing voice encoding parameters for use directly in the voice conversion software and thereby avoiding this step as part of the voice conversion platform. This could be accomplished at either or both ends, i.e. source and target, of the voice conversion process.

A ring tone application, according to this application is illustrated in FIG. 5. Depending on the ring tone feature resident on a particular communication device, ring tone processor 40 may be adapted to provide voice related ring tones to the audio user interface, i.e. speaker 24. A source voice signal may generated using a variety of applications, for example, contact list audio file 42, TTS processor 41, or a user recorded audio file 44. Other sources may be envisioned for conversion. The audio based ring tone is then processed through CPU 22 and audio processor 23 to generate an a speech related audio source signal. The source speech signal is then converted to a target speech signal in voice conversion unit 1 by decoding the source signal using target parameters from a target voice file 43 stored in memory 25. The target voice file can be selected from a list of voice files provided as part of the operating system of the communication device or by downloading from external sources available on the wireless network in which the communication system operates.

In operation, in the embodiment of FIG. 5, a ring tone processor 40 is adapted to accept voice based files for presentation as a ring tone, for broadcast by speaker 24 in response to an incoming call, text message, or email.

The ring tone application software is stored in memory 25 of communication device 2 and consists of program code adapted to cause the ring tone processor to generate a voice based signal for use by the audio processor 23 to be used as a voice base source signal for conversion. The voice source signal is processed in voice conversion unit 1 according to voice conversion techniques. A target selection software module is stored in memory 25 and may be selected through user interaction with the user interface of the communication device. The target selection software contains program code adapted to cause the voice conversion unit 1 to convert the source voice signal from the ring tone application, i.e. ring tone processor 40, based on a selected target voice signal from target voice file 43. The converted target signal is broadcast by speaker 24.

Although several processor and software modules are described above for illustration, it should be understood that these features and functions can be combined into one or more processors adapted to run one or more program products accessible in one or more memory sources.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

We claim:

1. A communication device comprising:
a transceiver for establishing and receiving communications on a wireless network;
a control processor for controlling the operation of the communication device;
an audio processor adapted to generate at least one source voice based audio signal in response to commands from the control processor;
a voice conversion unit adapted to process said source voice signal and convert said source voice signal to a target voice signal;
a memory adapted to store a selection of target voice based audio files;
a user interface adapted to allow a user to select at least one of said target voice audio files for use by the voice conversion unit as a target voice signal; and
a speaker for broadcasting the target voice signal.

2. A communication device, as described in claim 1, further comprising a message processor adapted to read the text of a message and convert the text to speech and wherein the speech is used as the source voice signal.

3. A communication device, as described in claim 2, further comprising a phone book application resident in the memory for operation by the control processor, said phone book application having a contact list and providing for the entry of an audio clip in association with a contact entry and wherein the audio clip is selectable for use as the target voice signal.

4. A communication device, as described in claim 1, wherein the target voice signal is select from a list of speech files, stored in memory, comprising at least one selected from the group consisting of: the voice of the sender of a message, the voice of the user, the voice of a celebrity, or a voice selected from audio files in a contact list.

5. A communication device, as described in claim 1, further comprising a ring tone processor adapted to generate voice based ring tones and wherein the voice based ring tones are used as the source voice signal.

6. A communication device, as described in claim 5, further comprising a phone book application resident in the memory for operation by the control processor, said phone book application having a contact list and providing for the entry of an audio clip in association with a contact entry and wherein the audio clip is selectable by the ring tone processor for use as the ring tone.

7. A communication device, as described in claim 5, further comprising a user recorded voice base audio file stored in memory and wherein the user recorded voice based audio file is selectable by the ring tone processor for use as a ring tone.

8. A communication device, as described in claim 5, further comprising a text to speech processor adapted to generate a voice for audibly presenting text and wherein the voice text is selectable by the ring tone processor for use as a ring tone.

9. A method of converting speech in a communication device comprising:
establishing at least one source of voice based audio signals in the communication device for broadcast on a speaker of said communication device;
providing a voice conversion framework in operative association with a control processor in the communication device, said voice conversion framework adapted to convert a source voice signal to a target voice signal;
storing in a memory of the communication device a selection of voice based audio files;
selecting at least one of the voice based audio signals from said at least one source for use as a source voice signal for conversion by the voice conversion framework;
selecting at least one of the voice based audio files from memory for use as a target voice signal in the voice conversion framework;
converting the source voice signal to the target voice signal in the voice conversion framework; and
broadcasting the target voice signal over a speaker of the communication device.

10. A method according to claim 9, further comprising selecting the source voice signal and the target voice signal through user interaction with the user interface of the communication device.

11. A method according to claim 9 further comprising;
providing a message processor adapted to read the text of a message and convert the text to speech and
selecting the text converted speech for use as the source voice signal.

12. A method according to claim 11 further comprising:
providing a phone book application resident in the memory for operation by the control processor, said phone book application having a contact list:
providing for the entry of an audio clip in association with a contact entry in said contact list; and
selecting the audio clip for use as the target voice signal.

13. A method according to claim 9, wherein the target voice signal is select from a list of speech files, stored in memory, comprising at least one selected from the group consisting of: the voice of the sender of a message, the voice of the user, the voice of a celebrity, or a voice selected from audio files in a contact list.

14. A method according to claim 9, further comprising:
providing a ring tone processor adapted to generate voice based ring tones; and
selecting the voice based ring tones for use as the source voice signal.

15. A method according to claim 14, further comprising:
providing a phone book application resident in the memory, said phone book application having a contact list;
providing for the entry of an audio clip in association with a contact entry; and
selecting the audio clip for use as the ring tone.

16. A method according to claim 14, further comprising;
providing a user recorded voice base audio file stored in memory: and
selecting the user recorded voice base audio filer use as a ring tone.

17. A method according to claim 14 further comprising:
providing a text to speech processor adapted to generate a voice for audibly presenting text; and
selecting the voice text for use as a ring tone.

18. A computer program product comprising:
a processor useable medium having processor readable code embodied therein for causing:
a control processor of a communication device to establish at least one source of voice based audio signals in the communication device for broadcast on a speaker of said communication device;
a memory medium to storing in a memory of the communication device a selection of voice based audio files;
the control processor, in response to user entry, to select at least one of the voice based audio signals from said at least one source for use as a source voice signal;
the control processor to select at least one of the voice based audio files from memory for use as a target voice signal in the voice conversion framework;
a voice conversion processor to convert the source voice signal to the target voice signal; and
an audio processor to broadcast the target voice signal over a speaker of the communication device.

19. A mobile communication device comprising:
a transceiver for establishing and receiving communications on a wireless network;
a control processor for controlling the operation of the mobile communication device;
an audio processor adapted to generate at least one source voice based audio signal in response to commands from the control processor;
a voice conversion unit adapted to process said source voice signal and convert said source voice signal to a target voice signal;
a memory adapted to store a selection of target voice based audio files;
a user interface adapted to allow a user to select at least one of said target voice audio files for use by the voice conversion unit as a target voice signal; and
a speaker for broadcasting the target voice signal.
